(19) United States
(12) Patent Application Publication
(10) Pub. No.: US 2017/0050602 A1
(43) Pub. Date: Feb. 23, 2017

(54) VEHICLE SEAT ASSEMBLY INCLUDING AN AIRBAG

(71) Applicant: Ford Global Technologies, LLC, Dearborn, MI (US)

(72) Inventor: Jeffrey Steven Vinton, Farmington Hills, MI (US)

(73) Assignee: FORD GLOBAL TECHNOLOGIES, LLC, Dearborn, MI (US)

(21) Appl. No.: 14/833,025

(22) Filed: Aug. 21, 2015

(51) Int. Cl. B60R 21/207; B60N 2/48; B60R 11/02

(52) U.S. Cl. CPC B60R 21/207; B60R 11/0229; B60N 2/4805; B60R 2021/2074; B60R 2011/0017

(57) ABSTRACT

A seat assembly for a vehicle includes a seat back and a display assembly supported by the seat back. The seat back includes a headrest supported by the seat back. An airbag is disposed in the headrest in an uninflated position and is inflatable from the uninflated position to an inflated position extending from the headrest. At least a portion of the display assembly is disposed between the airbag and the seat back when the airbag is in the inflated position. During a frontal impact of the vehicle, the airbag may reduce the likelihood of the occupant contacting components of the display assembly and/or the seat back.

### BACKGROUND

Display assemblies including electronic displays are becoming more prevalent in vehicles as customer demand for passenger entertainment increases. The electronic display offers visual access to information and entertainment, i.e. infotainment, and, for example, can be used to enlarge the display of hand held electronic devices for viewing stored movie playback, music videos, etc. A convenient location for the display assembly may be in a seat back of a front seat of the vehicle to be viewed by occupants seated in a rear row of seats.

Due to the introduction of the display assembly to the vehicle seat back, the rear occupant may contact the display assembly in a vehicle impact, e.g., a front end impact. As such, the display assembly may be designed to comply with Head Injury Criterion (HIC) testing standards. The HIC is a measure of the likelihood of head injury arising from an impact. The U.S. National Highway Traffic Safety Administration (NHTSA) utilizes the HIC as a tool for measuring head injury, and is a primary factor in determining the vehicle safety rating.

There remains an opportunity to design a vehicle seat assembly that reduces the likelihood of components of the display assembly and the seat back from coming in contact with the occupant which may result in a reduction of the impact energy transferred to the occupant.

### BRIEF DESCRIPTION OF THE DRAWINGS

FIG. 1 is a perspective view of a portion of a vehicle including a seat back, a display assembly with an airbag in an inflated position shown in hidden lines.

FIG. 2A is a side view of an occupant seated in front of the seat back with the display assembly, the airbag in an uninflated position, and an inflator all shown in hidden lines.

FIG. 2B is a side view of a head of the occupant moving toward the display assembly with the airbag in the inflated position.

FIG. 3 is a side view of the inflator and the airbag disposed in a headrest.

FIG. 4A is a side view of the airbag in communication with the inflator via the fill tube with the headrest in a raised position.

FIG. 4B is a side view of the airbag in communication with the inflator via the fill tube with the headrest in a lowered position.

FIG. 5 is a schematic of the impact absorbing system of the vehicle.

### DETAILED DESCRIPTION

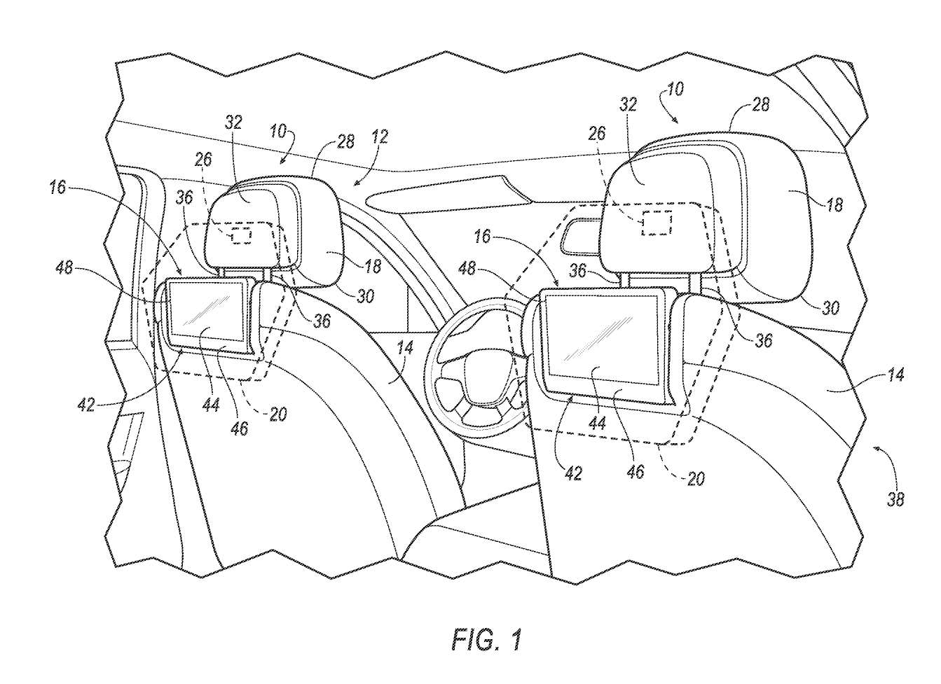

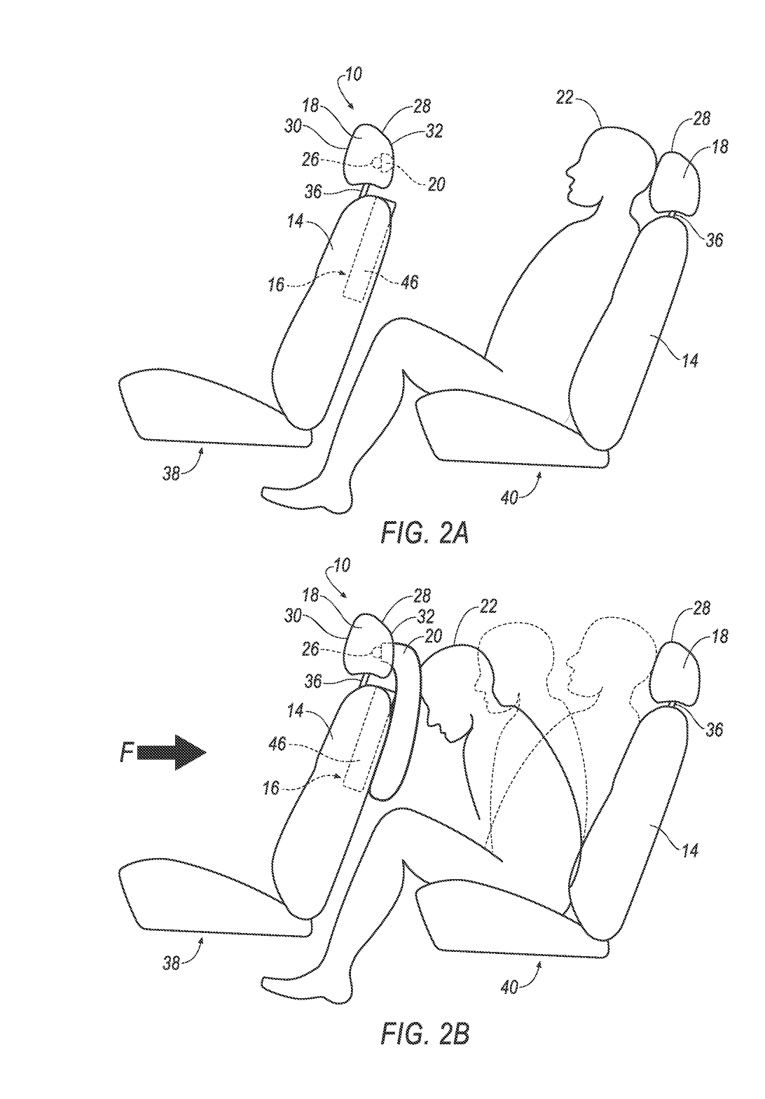

With reference to the Figures, wherein like numerals indicate like parts throughout the several views, FIGS. 1-4B show a seat assembly 10, 110 for a vehicle 12 that includes a seat back 14 and a display assembly 16 supported by the seat back 14. The seat back 14 includes a headrest 18 supported by the seat back 14. An airbag 20 is disposed in the headrest 18 in an uninflated position, as shown in FIGS. 2A and 3-4B, and is inflatable from the uninflated position to an inflated position, as shown in FIGS. 1 and 2B, extending from the headrest 18. At least a portion of the display assembly 16 is disposed between the airbag 20 and the seat back 14 when the airbag 20 is in the inflated position.

As shown in FIGS. 2A-2B, the occupant 22 may be seated in front of the display assembly 16, and may move toward the display assembly 16, for example, during a frontal impact of the vehicle 12. As the occupant 22, e.g., a head of the occupant 22, moves toward the display assembly 16 in a downward motion, the airbag 20 disposed in the headrest 18 may be selectively inflated based on the magnitude of the impact, as set forth below. For example, as set forth below, during a front end impact (identified with “F” in FIG. 2B), the airbag 20 may inflate causing the airbag 20 to extend along the display assembly 16 and the seat back 14, as shown in FIGS. 1 and 2B. In this situation, as the occupant 22 continues to move in a forward and downward motion, the airbag 20 in the inflated position may reduce the likelihood of the occupant 22 contacting components of the display assembly 16 and/or the seat back 14, which may result in a reduction of the impact energy transferred to the occupant 22.

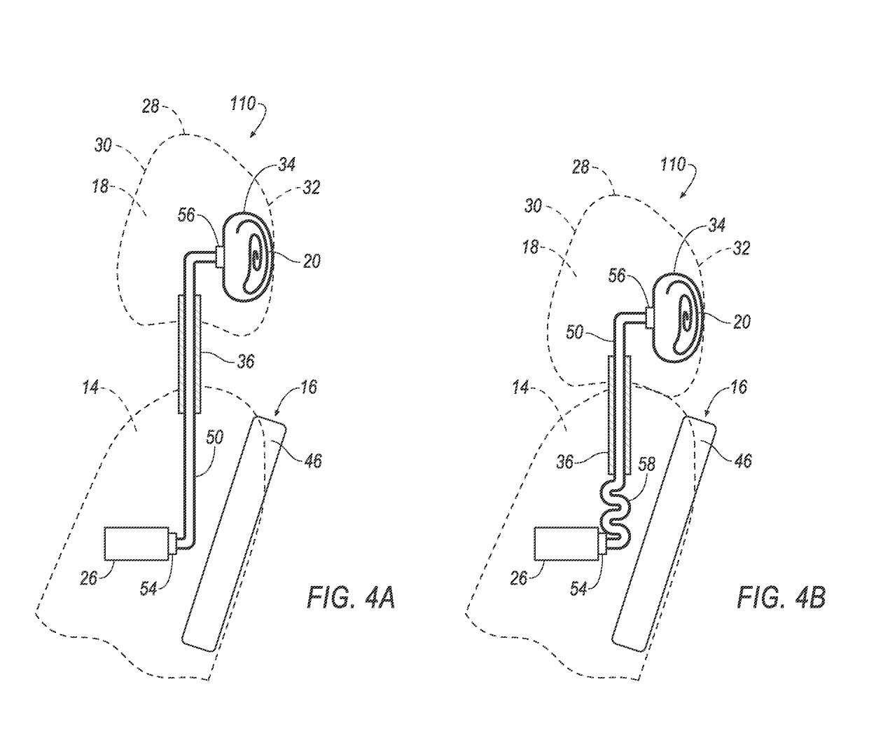

As set forth below, the airbag 20 may be a component of an impact absorbing system 24. The impact absorbing system 24 may include an inflator 26 in communication with the airbag 20. The inflator 26 may be supported by the seat back 14 or by the headrest 18. Specifically, a first embodiment of the seat assembly 10 with the inflator in the head rest is shown in FIGS. 1-3, and a second embodiment of the seat assembly 110 with the inflator 26 in the seat back 14 is shown in FIGS. 4A-4B. Common numerals are used to identify common features in the various embodiments.

As set forth further below for example, the impact absorbing system 24 may sense an impact of the vehicle 12 and may trigger inflation of the airbag 20 in response to the sensed impact. In addition, the impact absorbing system 24 may sense the type of impact, e.g., based on direction, magnitude, etc., and may trigger inflation of the airbag 20 in response to the type of impact, e.g., in response to a frontal impact.

With reference to FIGS. 1-4B, the headrest 18 may include a headrest pad (not shown) and a headrest cover 28. The headrest cover 28 may cover the airbag 20 when the airbag 20 is in the uninflated position, as shown in FIGS. 2A and 3-4B.

The headrest cover 28 may include a main portion 30 and a break-away portion 32 to allow the airbag 20 to inflate through the headrest cover 28 to the inflated position, as shown in FIGS. 1 and 2B. The break-away portion 32 may be formed by weakened regions, formed by partially cutting or otherwise weakening the headrest cover 28 locally allowing the airbag 20 to extend from the headrest 18 when inflated from the uninflated position to the inflated position. The main portion 30 may be formed of any suitable material. For example, the main portion 30 may be fabric, polyester, plastic, thermoplastic polyester elastomers (TPPE), etc.

The break-away portion 32 may be integrally formed with the main portion 30 of the headrest cover 28, i.e., formed simultaneously as a single continuous unit. For example, the main portion 30 and the break-away portion 32 may be co-molded. Alternatively, the break-away portion 32 and the main portion 30 may be formed separately and subsequently fixed together, e.g., the break-away portion 32 may be fastened, adhered, bonded, etc., to the main portion 30. The break-away portion 32 may be formed of the same material as the main portion 30, or any other suitable material, e.g., thermoplastic polyester elastomers (TPPE), etc.

As shown in FIGS. 2A, 3-4B, the airbag 20 may be completely enclosed within the headrest 18 when the airbag 20 is in the uninflated position. The airbag 20, when activated by the impact absorbing system 24, is configured to inflate to the inflatable position as shown in FIGS. 1 and 2B. More specifically, a membrane 34 may enclose the airbag 20 and the membrane 34 may be configured to rupture when the airbag 20 is inflated. When the airbag 20 inflates from the uninflated position to the inflated position, the airbag 20 ruptures the membrane 34 and tears open the break-away portion 32 of the headrest cover 28. In either case, the break-away portion 32 is located in back of the headrest 18 facing the occupant 22, as shown in FIGS. 2A-2B.

To achieve a smaller volume for mounting in the headrest 18, the airbag 20 may be vacuumed packed, i.e. folded, and sealed within the membrane 34. The airbag 20 may be formed of any suitable material, e.g., woven polymer, nylon 6-6, etc. The membrane 34 may be formed of any suitable material, e.g., polyester film, polyethylene terephthalate (PET), etc.

With reference to FIGS. 1-4B, the seat assembly 10, 110 may include one or more posts 36 extending from the seat back 14 to the headrest 18, e.g., two posts 36 are shown in FIG. 1. The headrest 18 may be moveable relative to the seat back 14 in a direction along the post 36 between a raised position, as shown in FIG. 4A, and a lowered position, as shown in FIG. 4B. At least one of the seat back 14 and the headrest 18 are moveably engaged with the post 36. For example, as shown in FIGS. 4A-4B, the post 36 may be fixed to the headrest 18, and as the headrest 18 moves from the raised position to the lowered position, the seat back 14 may be moveably engaged with the post 36 while the post 36 travels into the seat back 14. As another example, the post 36 may be fixed to the seat back 14, and as the headrest 18 moves relative to the post 36 from the raised position to the lowered position, the headrest 18 may be moveably engaged with the post 36 while the post 36 travels into the headrest 18. As yet another example, the post 36 may be moveably engaged with both the seat back 14 and the headrest 18, and as the headrest 18 moves from the raised position to the lowered position, the post 36 may move relative to both the seat back 14 and the headrest 18.

The post 36 may be formed of any suitable material, e.g., metal such as steel, aluminum, etc. Alternatively, for example, the post 36 may be formed of an engineered plastic, e.g., acrylonitrile butadiene styrene (ABS), sheet molding compound (SMC) composites, etc. The post 36 may have any suitable solid cross-sectional shape, e.g. circular, oval, rectangular, rounded rectangular, etc. The post 36 may be hollow as shown in cross-section, for example, in FIGS. 4A-4B, or may be solid.

With reference to the Figures, the vehicle 12 may include two adjacent seat assemblies 10, 110, i.e., arranged in a front row 38. Similarly, with reference to FIGS. 2A-2B, the vehicle 12 may include two seat assemblies 10, 110 arranged in the front row 38 and a rear row 40. The vehicle 12 may include any suitable number of seat assemblies 10, 110, arranged in any suitable number of rows, and one or more of the seat assemblies 10, 110 may include the seat back 14, headrest 18, display assembly 16, and airbag 20 described herein. The vehicle 12 may be of any suitable type, e.g. a car, truck, SUV, etc.

With reference to FIG. 1, the display assembly 16 may include an electronic display 42 and may be of any suitable type for displaying images and/or video, e.g., entertainment, informational, navigational, etc. The electronic display 42 may be of any suitable type, for example, a liquid crystal (LCD) display, light emitting diode (LED) display, etc. The electronic display 42 may include one or more input features, e.g., touch screen, buttons, knobs, etc., for inputting and/or selecting data. The electronic display 42 may also include audio speakers.

As shown in FIG. 1, the electronic display 42 may include a screen 44 mounted to a housing 46. The screen 44 may be fixed to the housing 46, and the housing 46 may extend around a periphery 48 of the screen 44. The housing 46 may be fixed to the seat back 14. The housing 46 may house components of the electronic display 42, e.g., wires, electronic circuitry, etc. The housing 46 may, for example, be formed of any suitable material such as a polymer, e.g., nylon, plastic, polypropylene (PP), acrylonitrile butadiene styrene (ABS), vinyl, etc.

The inflator 26 in communication with the airbag 20 expands the airbag 20 with an inflation medium, such as a gas. The inflator 26 may be, for example, a pyrotechnic inflator that uses a chemical reaction to drive inflation medium to the airbag 20. More specifically, when the impact absorbing system 24 activates the pyrotechnic inflator, a chemical reaction occurs causing the portion of the inflator 26 within the membrane 34 to burst allowing the inflation medium to fill the airbag 20. The inflator 26 of the first embodiment of the seat assembly 10, for example, may be a pyrotechnic inflator. Alternatively, the inflator 26 may be, for example, a cold-gas inflator which, when activated, ignites a pyrotechnic charge that creates an opening for releasing the pressurized inflation medium to the airbag 20 via a fill tube 50 (described further below). The inflator 26 of the second embodiment of the seat assembly 110, for example, may be a cold-gas inflator. Alternatively, the inflator 26 may be of any suitable type, for example, a hybrid inflator.

With reference to FIGS. 1 and 2B and as set forth above, when the airbag 20 inflates from the uninflated position to the inflated position, at least a portion of the display assembly 16 may be disposed between airbag 20 and the seat back 14. For example, the display assembly 16 may be covered by the airbag 20 in the inflated position, i.e., to prevent any portion of the display assembly 16 to be exposed to the occupant 22 seated behind the display assembly 16. The airbag 20 is configured, i.e., the airbag 20 is sized and shaped, to inflate in a direction away from and downwardly from the headrest 18 and along the electronic display 42.

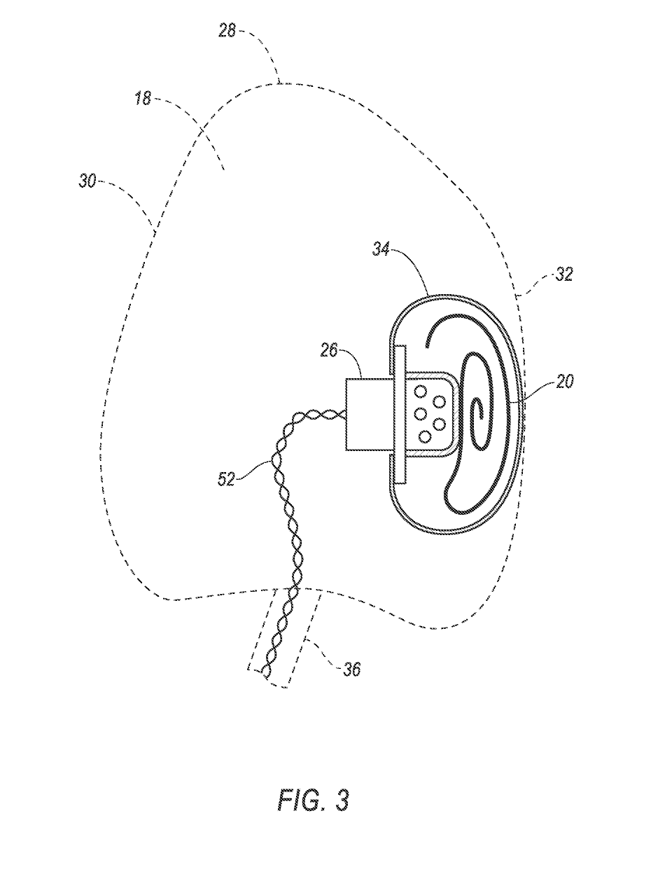

As set forth above, the first embodiment of the seat assembly 10 is shown in FIG. 3, in which the inflator 26 and the airbag 20 are housed together in the headrest 18 and move together as a unit with the headrest 18 as the headrest 18 moves between the raised position and the lowered position. The wiring 52 may extend from the inflator 26 and may extend through the post 36, as shown in FIG. 3.

As set forth above, the second embodiment of the seat assembly 110 is shown in FIG. 4A-4B, in which the inflator 26 is supported in the seat back 14. The inflator 26 may be located within the seat back 14 in communication with the airbag 20 to expand the airbag 20 with an inflation medium, such as a gas through the fill tube 50. A fill tube 50 may extend from the inflator 26 to the airbag 20.

The fill tube 50 may include a first end 54 fixed to the inflator 26 and a second end 56 spaced from the first end 54 and fixed to the airbag 20. The fill tube 50 extends through the post 36 between the first end 54 and the second end 56.

As set forth above, the post 36 may be moveably engaged with at least one of the seat back 14 and the headrest 18. The fill tube 50 may include slack that allows the headrest 18 to move relative to the seat back 14 while maintaining connection of the fill tube 50 to the inflator 26 and the airbag 20. In particular, as shown in FIG. 4B, when the headrest 18 moves relative to the seat back 14 from the raised position to the lowered position, the fill tube 50 may include a bend 58 in the seat back 14 when the headrest 18 is in the lowered position. Alternatively, or in addition to the bend 58 in the seat back 14, the full tube 50 may include the bend 58 in the headrest 18 when the headrest 18 is in the lowered position. As yet another alternative, the fill tube 50 may include the bend 58 in the headrest 18 and the bend 58 in the seat back 14 when the headrest 18 is in the lowered position.

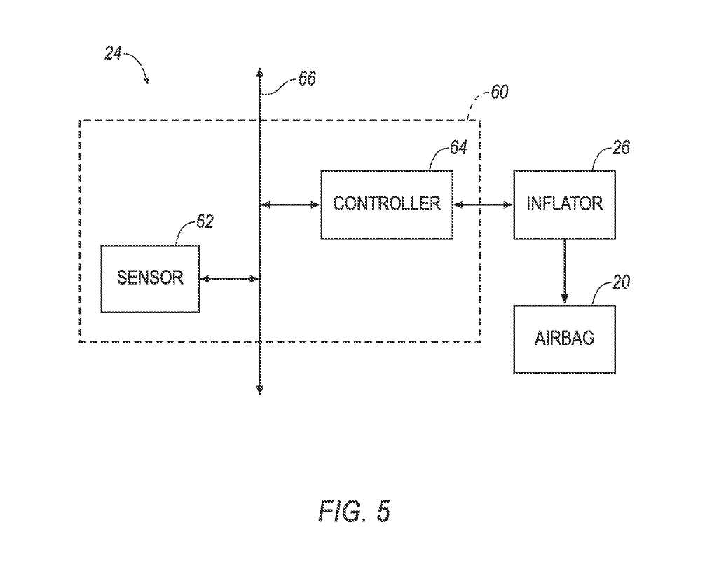

A schematic of the impact absorbing system 24 which includes an impact sensing system 60, the inflator 26, and the airbag 20 is shown in FIG. 5. The impact sensing system 60 may include at least one sensor 62 for sensing impact of the vehicle 12, and a controller 64 in communication with the sensor 62 and the inflator 26 for activating the inflator 26, e.g., for providing an impulse to a pyrotechnic charge of the inflator 26, when the sensor 62 senses an impact of the vehicle 12. Alternatively or additionally to sensing impact, the impact sensing system 60 may be configured to sense impact prior to impact, i.e., pre-impact sensing. The sensor 62 may be of any suitable type, e.g., using radar, lidar, and/or a vision system. The vision system may include one or more cameras, CCD image sensors, and/or CMOS image sensor, etc.

The controller 64 may be a microprocessor-based controller. The sensor 62 is in communication with the controller 64 to communicate data to the controller 64. Based on the data communicated by the sensor 62, the controller 64 instructs the inflator 26 to activate. The controller 64 may be programmed to activate the inflator 26 to inflate the airbag 20 to the inflated position in response at least to a front impact of the vehicle 12. Specifically, the sensor 62 may sense the front impact and, based on the sensed front impact, the controller 64 may provide an instruction to the inflator 26 to inflate the airbag 20.

The controller 64 and the sensor 62 may be connected to a communication bus 66, such as a controller area network (CAN) bus, of the vehicle 12. The controller 64 may use information from the communication bus 66 to control the activation of the inflator 26. The inflator 26 may be connected to the controller 64, as shown in FIG. 5, or may be connected directly to the communication bus 66.

In operation, the airbag 20 is in the uninflated position, as shown in FIGS. 2A and 3-4B, under normal operating conditions of the vehicle 12. When the sensor 62 senses an impact of the vehicle 12, the impact sensing system 60 triggers the inflator 26 to inflate the airbag 20 with the inflation medium from the uninflated position to the inflated position. In particular, based on the type of impact sensed by the impact sensing system 60, the impact sensing system 60 inflates the airbag 20 to the inflated position as shown in FIGS. 1 and 2B.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A seat assembly comprising:
a seat back;
a display assembly supported by the seat back;
a headrest supported by the seat back; and
an airbag disposed in the headrest in an uninflated position and being inflatable from the uninflated position to an inflated position extending from the headrest;
the display assembly being disposed between the airbag and the seat back when the airbag is in the inflated position;
the airbag configured to inflate away from and downwardly from the headrest along the display assembly to the inflated position, wherein the airbag covers the display assembly in the inflated position.

2. The seat assembly as set forth in claim 1, further comprising a post extending from the seat back to the headrest.

3. The seat assembly as set forth in claim 2, wherein at least one of the seat back and the headrest are moveably engaged with the post.

4. The seat assembly as set forth in claim 2, further comprising an inflator in communication with the airbag.

5. The seat assembly as set forth in claim 4, wherein the inflator is disposed in the headrest.

6. The seat assembly as set forth in claim 5, further comprising a membrane enclosing the inflator and the airbag in the uninflated position.

7. The seat assembly as set forth in claim 4, wherein the inflator is disposed in the seat back.

8. The seat assembly as set forth in claim 7, further comprising a fill tube extending through the post and in communication with the inflator and the airbag.

9. The seat assembly as set forth in claim 8, wherein the headrest is moveable along the post between a raised position and a lowered position, the fill tube including a bend when the headrest is in the lowered position, wherein the bend is straight when the headrest is in the raised position.

10. The seat assembly as set forth in claim 1, wherein the airbag is vacuumed packed.

11. An impact absorbing system comprising:
a seat back;
a display assembly supported by the seat back;
a headrest supported by the seat back;
an airbag supported by the headrest and being inflatable from the uninflated position to an inflated position; the display assembly being disposed between the airbag and the seat back when the airbag is in the inflated position;
an inflator in communication with the airbag; and
a controller programmed to activate the inflator to inflate the airbag to the inflated position in response at least to a front impact of the vehicle;
the airbag configured to inflate away from and downwardly from the headrest along the display assembly to the inflated position, wherein the airbag covers the display assembly in the inflated position.

12. The impact absorbing system as set forth in claim 11, further comprising a post extending from the seat back to the headrest.

13. The impact absorbing system as set forth in claim 12, wherein as least one of the seat back and the headrest are moveably engaged with the post.

14. The impact absorbing system as set forth in claim 12, wherein the inflator is disposed in the headrest.

15. The impact absorbing system as set forth in claim 14, further comprising a membrane enclosing the inflator and the airbag in the uninflated position.

16. The impact absorbing system as set forth in claim 12, wherein the inflator is disposed in the seat back.

17. The impact absorbing system as set forth in claim 16, further comprising a fill tube extending through the post and in communication with the inflator and the airbag.

18. The impact absorbing system as set forth in claim 17, wherein the headrest is moveable along the post between a raised position and a lowered position, the fill tube including a bend when the headrest is in the lowered position, wherein the bend is straight when the headrest is in the raised position.

19. The seat assembly as set forth in claim 1, wherein the display assembly includes a screen and a housing extending around a periphery of the screen.

20. The seat assembly as set forth in claim 1, wherein the display assembly includes a top end adjacent to the headrest and a bottom end opposite the top end, the airbag in the inflated position extending to the bottom end of the display assembly.
